(19) United States
(12) Patent Application Publication
(10) Pub. No.: US 2023/0386086 A1
(43) Pub. Date: Nov. 30, 2023

(54) VIDEO COMPRESSION

(71) Applicant: Microsoft Technology Licensing, LLC, Redmond, WA (US)

(72) Inventors: Marc Andre Leon POLLEFEYS, Zurich (CH); Dag Birger FROMMHOLD, Metzingen (DE)

(21) Appl. No.: 17/829,265

(22) Filed: May 31, 2022

(51) Int. Cl. G06T 9/00; G06T 3/40

(52) U.S. Cl. CPC G06T 9/001; G06T 3/40

(57) ABSTRACT

A decoder receives a compressed red green blue depth, RGBD, frame of a video. The decoder accesses a reference RGBD frame. The decoder reprojects the reference RGBD frame using a depth channel of the reference RGBD frame and a camera pose, to compute a reprojected version of the reference frame. The decoder uses the reprojected version of the reference frame to decode the compressed RGBD frame.

### BACKGROUND

Video is typically compressed before being transmitted over communications networks or stored on storage media in order to save bandwidth and storage capacity. A video encoder compresses a video signal into a compact form for transmission or storage. A video decoder accesses the encoded video signal and is able to decode the video so that the decoded video is suitable for display. Video encoders seek to reduce redundancy in video signals in such a way that a decoder is able to reverse the encoding and produce a video signal close to the original. Lossy video encoders are used in some cases where it is acceptable for some information from the original video signal to be lost in an irreversible way.

The embodiments described below are not limited to implementations which solve any or all of the disadvantages of known video encoders and video decoders.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples a decoder receives a compressed red green blue depth, RGBD, frame of a video. The decoder accesses a reference RGBD frame. The decoder reprojects the reference RGBD frame using a depth channel of the reference RGBD frame and a camera pose, to compute a reprojected version of the reference frame. The decoder uses the reprojected version of the reference frame to decode the compressed RGBD frame.

In various examples, an encoder receives a red green blue depth, RGBD, frame of a video. The encoder accesses a reference RGBD frame and reprojects the reference RGBD frame using a depth channel of the reference RGBD frame and a camera pose, to compute a reprojected version of the reference frame. The encoder uses the reprojected version of the reference frame to encode the compressed RGBD frame.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an encoder and a decoder;

FIG. 2 is a schematic diagram of various deployments of an encoder and a decoder;

FIG. 3 is a schematic diagram of a head mounted device and a companion computing device for use with the encoder and decoder of FIG. 1;

FIG. 4 is a flow diagram of a method performed by an encoder and a method performed by a decoder;

FIG. 5A is a schematic diagram of encoding circuitry;

FIG. 5B is a schematic diagram of decoding circuitry;

FIG. 6 illustrates an exemplary computing-based device in which embodiments of an encoder and/or decoder are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

The term pose is used to refer to a position and orientation, such as a 3D position and orientation.

A red green blue depth RGBD frame is an image comprising a red channel, a blue channel, a green channel and a depth channel. The resolutions of the channels are different in some cases. An RGBD frame is captured using capture devices or is synthetic such as where it has been rendered from a 3D model.

Video compression is useful in many scenarios where video is to be stored or transmitted between entities over a communications network. There is an ongoing desire to improve efficiency and/or performance of video compression.

The inventors have recognized that where a video includes depth data, such as in the case of red green blue depth RGBD videos, it is possible to use the depth channel and a camera pose to improve compression of the RGBD video by reprojecting a reference frame. In some cases the RGBD video is compressed to a smaller size as compared with not reprojecting the reference frame and yet quality of decoded video remains high. In some cases the RGBD video is compressed in such a way as to achieve a higher quality once decoded. A video encoder compresses an RGBD frame to produce a plurality of motion vectors and corresponding residuals. By using reprojection of a reference frame as described herein the motion vectors and residuals are smaller so that compression is facilitated.

In order to compress a frame of a video an encoder uses a reference frame. The reference frame is a frame of the video such as a previous frame of the video, or a predicted future frame of the video. The encoder computes motion vectors and residuals which describe a difference between the reference frame and a frame of the video to be encoded. The motion vectors and residuals which are computed are the compressed video frame and are stored or sent to another entity. A decoder is able to access the motion vectors and residuals and reconstruct the video frame by applying the motion vectors and residuals to a version of the reference frame known to the decoder.

Where the video depicts a 3D scene as viewed from a camera pose which is moving, it is often difficult for the motion vectors to accurately describe differences between the video frame and the reference frame. This is exacerbated where the 3D scene is complex such as in the case of a person's face in the scene or in the case of synthetic scene of a whole city. As a result the quality of the video compression is reduced since the motion vectors and residuals can't capture the differences correctly and/or are large.

In various examples herein the reference frame is reprojected using a depth channel of the reference frame and a camera pose. In this way the reference frame is better able to account for movement of a camera pose in a 3D scene. As a result the reference frame becomes similar to a frame to be encoded and the resulting motion vectors and residuals are small and yet well able to explain the delta with respect to the reference frame. Without the reprojection, there are complex differences between the reference frame and the frame to be compressed which are difficult to describe using motion vectors and residuals.

In various examples an encoder receives a red green blue depth, RGBD, frame of a video to be compressed. The encoder has access to a reference RGBD frame such as a previous frame of the video or a predicted frame of the video. The encoder reprojects the reference RGBD frame using a depth channel of the reference RGBD frame and a camera pose, to compute a reprojected version of the reference frame. In an example the camera pose is the camera pose of the rendered frame that is to be encoded. The encoder uses the reprojected version of the reference frame to encode the compressed RGBD frame. By reprojecting the reference frame the reference frame becomes similar to the frame to be encoded since the reprojection enables the 3D nature of the scene depicted in the RGBD frame to be taken into account with respect to the camera pose. Thus the encoder is able to compute a high quality compression of the RGBD frame with respect to the reprojected reference frame. In many applications RGBD frames are used as compared with RGB frames since the depth channel is useful for compositing or other purposes. Compositing is where a virtual object such as a cursor or menu item is to be displayed as a hologram in a mixed reality display in such a way as to take into account occlusions resulting from surfaces in the 3D scene (i.e. without merely overlaying the virtual object onto the scene). The resolution of the depth channel is significantly lower than the resolution of the RGB channels in some cases such that the bandwidth used to send the depth channel is reduced. Despite the lower resolution of the depth channel the encoding and decoding operations described herein perform well.

In examples, reprojecting the reference RGBD frame comprises computing a forward reprojection by computing a rendering from a depth channel of the RGBD frame according to the camera pose; or reprojecting the reference RGBD frame comprises computing a backward projection by searching a depth buffer. These are effective ways of computing the reprojection of the reference frame which enable the reference frame to take into account complexity in the 3D scene which is depicted.

In various examples, the camera pose is computed from camera pose motion data shared between the decoder and an encoder which encoded the compressed RGBD frame. In this way changes in the camera pose are accounted for in an effective manner.

In various examples, the camera pose data shared between the decoder and encoder is shared by sending data about pose of a virtual camera used to render from a 3D model between the encoder and decoder. This facilitates deployments of the encoder with a high compute power renderer as explained in more details below. As the pose data is compact it may be sent without being compressed.

In some examples the camera pose is the pose of the reference frame (which is typically the previous rendered frame). The reference frame is reprojected into the space of the rendered frame.

In various examples, encoding the compressed RGBD frame comprises using circuitry comprising a reference frame buffer and injecting the reprojected version of the reference frame into the reference frame buffer. In this way a hardware encoder is upgraded by being able to accept the reprojection into the reference frame buffer.

In various examples a decoder receives a compressed red green blue depth, RGBD, frame of a video. The decoder has access to a reference RGBD frame. The decoder reprojects the reference RGBD frame using a depth channel of the reference RGBD frame and a camera pose, to compute a reprojected version of the reference frame. The decoder uses the reprojected version of the reference frame to decode the compressed RGBD frame.

In some cases the compressed RGBD frame has been obtained by rendering from a 3D model to compute an RGBD frame and then compressing the RGBD frame using an encoder as described herein. The compressed RGBD frame is suitable for sending over a communications network such as from a cloud remote rendering service, an edge computing device, or a companion device.

In some cases the compressed RGBD frame depth has been obtained by capturing an RGBD frame of a 3D scene and then compressing the RGBD frame. Thus a head mounted device or other capture device is able to capture and compress RGBD frames for storage or transmission to another entity.

In examples, reprojecting the reference RGBD frame comprises computing a forward reprojection by computing a rendering from a depth channel of the RGBD frame according to the camera pose. Forward reprojection is described in more detail below and is well suited where the computing hardware facilitates rasterization.

In examples, reprojecting the reference RGBD frame comprises computing a backward projection by searching a depth buffer. Backward reprojection determines, for each pixel, where a reprojected ray cast from a rendering camera extending to a reprojected pixel intercepts the depth channel.

The decoder receives the compressed RGBD frame by receiving a plurality of motion vectors and residuals. The decoder decodes the compressed RGBD frame by applying the motion vectors and residuals to blocks of the reprojected version of the reference frame. This gives an effective way to decompress which is implementable using hardware circuitry.

In examples decoding the compressed RGBD frame comprises using circuitry comprising a reference frame buffer and injecting the reprojected version of the reference frame into the reference frame buffer. In this way a decoder can be upgraded by injecting a reprojection into the reference frame buffer.

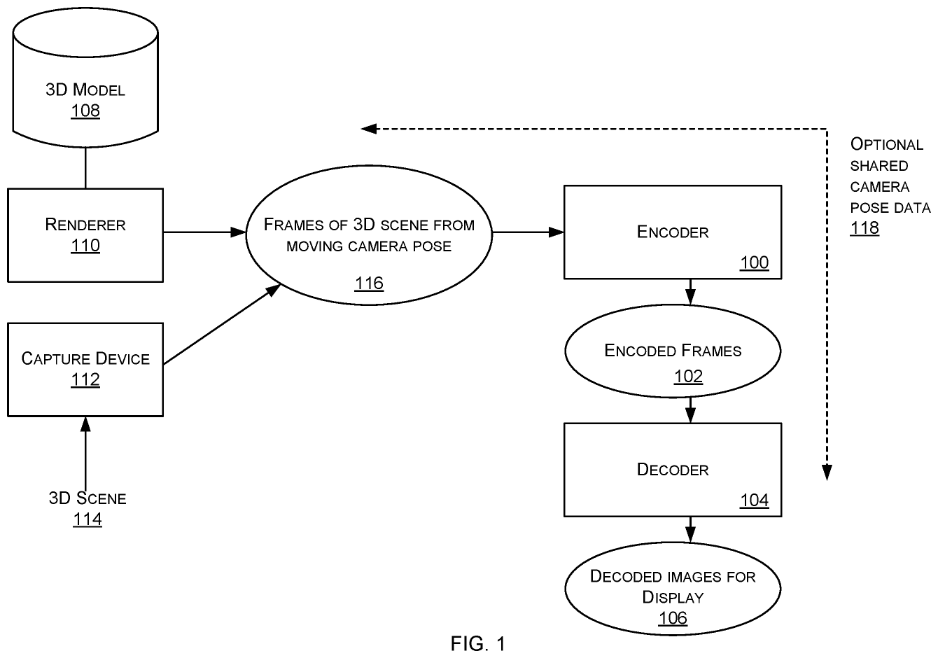

FIG. 1 is a schematic diagram of an encoder 100 and a decoder 104. The encoder 100 encodes a frame depicting a 3D scene. The frame has an associated camera pose which is a pose of a virtual camera used in rendering the frame from a 3D model 108 using renderer 110, or is a pose of a capture device 112 which captured the frame depicting 3D scene 114. The frame is part of a stream of frames 116 forming a video. Each frame is a red green blue depth RGBD frame which is an image having a red channel, a green channel a blue channel and a depth channel. The camera pose varies between frames of the video such as where the capture device 112 is moving in the 3D scene 114 or where the pose of the virtual camera used by renderer 110 moves with respect to the 3D model 108. The camera pose is said to have motion or to follow a trajectory or path. In an example the camera pose has motion where the capture device 112 is in a head mounted device worn by a wearer who is walking in the 3D scene 114. In another example the camera pose has motion where the renderer 110 is rendering frames from the 3D model 108 to depict a fly over of a city represented by the 3D model 108.

The encoder 100 encodes the frames 116 to produce encoded frames 102. The encoded frames comprise motion vectors and residuals.

The encoder 100 divides a frame into blocks and for each block, computes a motion vector. The motion vector describes a translation which when applied to the block identifies part of a reference frame which is similar to the block. Any difference between the block and the identified part of the reference frame is recorded as a residual. Thus for each block in the frame the encoder computes a motion vector and a residual. The motion vectors and residuals take less storage capacity than the frame. Thus the motion vectors and residuals are a compression or encoding of the frame.

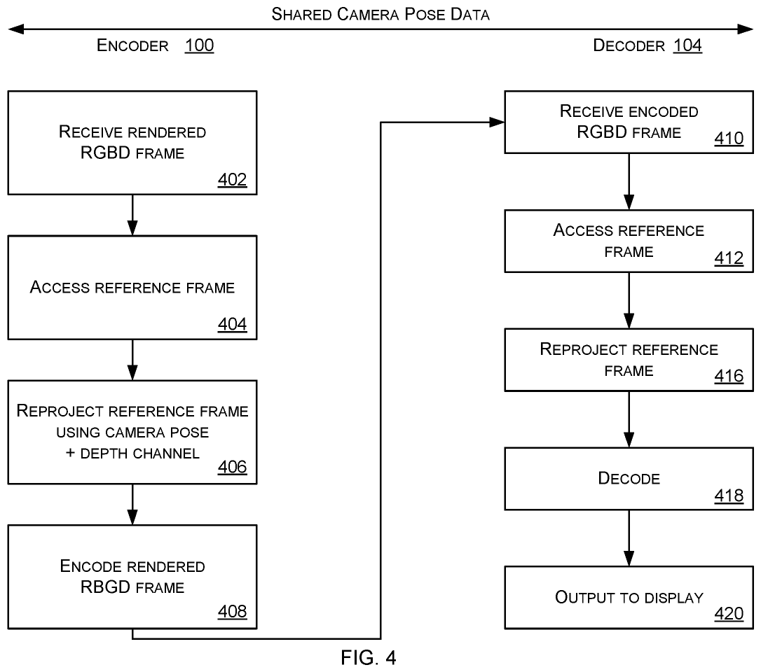

The reference frame is a frame of the video available to the encoder. The reference frame is a previous frame of the video. Before using the reference frame to compute the motion vectors and residuals the encoder reprojects the reference frame using a camera pose and a depth channel of the reference frame. The camera pose is the camera pose of the rendered frame that is to be encoded. More detail about how the reprojection is computed is given with reference to FIG. 4.

Where a capture device 112 is used, it has a pose tracker which tracks a pose of the capture device 112 and provides the tracked pose to the encoder 100 for use in reprojecting the reference frame. The pose tracker tracks the pose of the capture device by fitting captured sensor data to a 3D model and/or by using sensor data such as inertial measurement unit data, global positioning system GPS data, accelerometer data or other captured sensor data.

Where a renderer 110 is used, it sends information about a pose of a virtual camera it uses to the encoder 100.

The encoded frame, comprising motion vectors and residuals is stored and/or transmitted to a decoder 104. The decoder has the reference frame used by the encoder since the reference frame is sent by the encoder to the decoder at intervals using conventional intra coding. The decoder reprojects the reference frame using a depth channel of the reference frame and a camera pose.

The camera pose is computed from camera pose data shared 118 between the decoder and an encoder which encoded the compressed RGBD frame. In some cases the camera pose data is shared between the decoder and encoder by sending data about the pose between the encoder and decoder. In an example the camera pose used by the decoder is a camera pose of the encoded frame. For example, the camera pose is in a trajectory of a camera pose of a camera used to render the compressed RGBD frame or a trajectory of a pose of a camera used to capture the compressed RGBD frame.

Using the reprojected reference frame the decoder decodes the encoded frames 102. The decoding is done by using the motion vectors to translate the blocks of the reference frame and by adding the residuals. The decoded frames 106 are output for display at any suitable display device such as a head mounted display device, a television screen, a laptop computer, a video game apparatus or other display device.

The reprojection of a reference frame of the disclosure operates in an unconventional manner to achieve improved compression of RGBD frames of the disclosure.

The reprojection of the reference frame improves the functioning of the underlying computing device at least by giving enhanced compression of RGBD frames. As a result of the enhanced compression there is more efficient use of bandwidth, computing resources, memory resources.

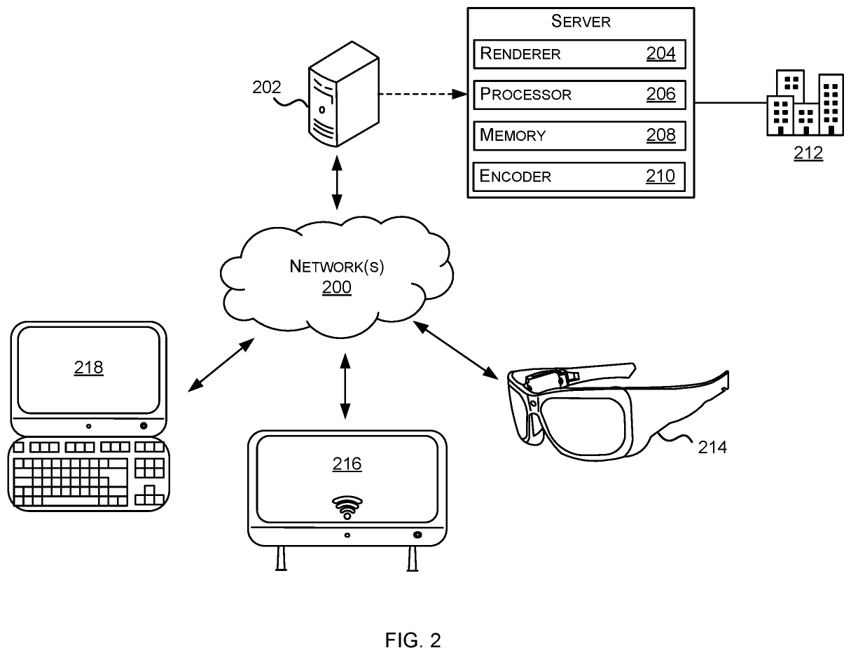

FIG. 2 is a schematic diagram of various example deployments of an encoder and a decoder. In an example, a server 202 is connected to a communications network 200. The server 202 comprises a renderer 204, processor 206, memory 208 and encoder 210 and has access to a complex 3D model such as of a city 212 or other 3D scene. The server 202 is deployed in the cloud such as at a data centre in some cases where a remote rendering service is provided. In some cases the server 202 is deployed at the edge such as at a 5G base station or other computing node with capability to render from complex 3D models will many millions or billions of parameters. The server 202 computes rendered RGBD frames, encodes the RGBD frames and sends the encoded RGBD frames to client devices such as any of HMD 214, smart television 216, laptop computer 218 or other client devices. The client devices have decoders such as the decoder of FIG. 1 and are able to decode the encoded RGBD frames and provide the decoded RGBD frames to a display. In this way it is possible for highly complex 3D models to be rendered from effectively using computing resources at server 202. Client devices typically do not have enough computing resources to enable rendering from complex models with millions or billions of parameters. By encoding the rendered RGBD frames bandwidth of the network 200 is conserved.

As explained with reference to FIG. 1 it is also possible for a capture device to capture RGBD frames which are to be encoded. The HMD 214 of FIG. 1 has capture devices and a pose tracker. The HMD 214 also comprises an encoder in some examples and encodes the captured RGBD frames before sending the encoded RGBD frames to another entity over network 200 or storing the encoded RGBD frames.

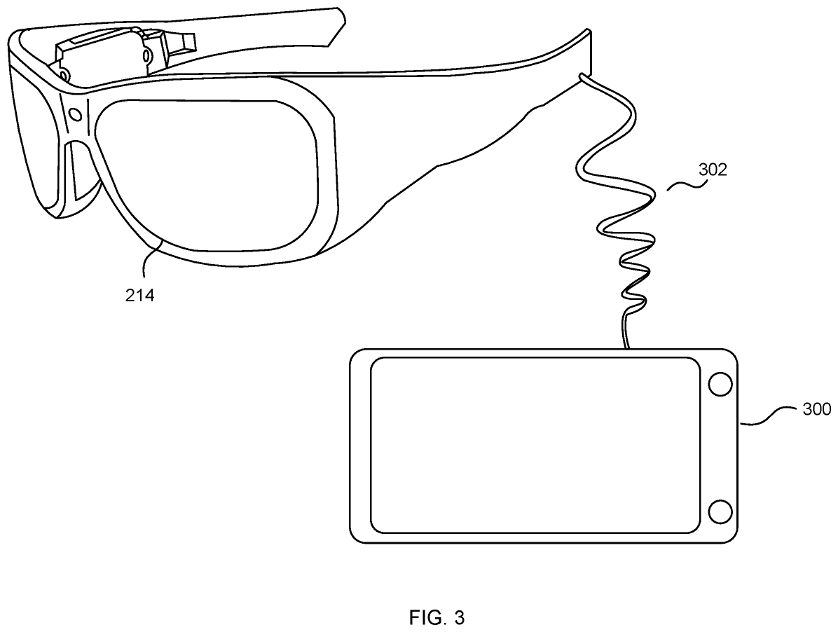

FIG. 3 is a schematic diagram of a head mounted device and a companion computing device for use with the encoder and decoder of FIG. 1. In this case HMD 214 is connected wirelessly or using a wired connection 302 to companion computing device 300. The companion computing device 300 is a smart phone, smart watch or any other companion computing device which is portable such as by being handheld or wearable. A renderer in the companion computing device 300 renders RGBD frames from a 3D model and compresses the RGBD frames using an encoder such as the encoder of FIG. 1. The encoded RGBD frames are sent to the HMD 214 over the wired connection 302 or wireless connection. The HMD 214 has a decoder such as the decoder of FIG. 1. which decodes the encoded RGBD frames and makes them available for display such as by projection into pupils of a wearer of the HMD.

FIG. 4 is a flow diagram of a method performed by an encoder 100 and a method performed by a decoder 104 such as those of FIG. 1.

The encoder receives an RGBD frame 402 of a video. As mentioned with reference to FIG. 1 the RGBD frame 402 is received from a renderer after having been rendered from a complex 3D model according to a virtual camera pose; or is receive from a capture device.

The encoder accesses 404 a reference frame. The reference frame is a previous frame of the video. The encoder reprojects 406 the reference frame using a camera pose and a depth channel of the reference RGBD frame.

In an example the reprojection is forward reprojection. In forward reprojection a rendering is computed from a depth channel of the RGBD frame according to the camera pose. In an example, the depth channel of the RGBD is a 2.5D representation of the 3D model and is textured using the RGB channels of the RGBD frame. A rendering is then computed from the 2.5D representation with texture according to the camera pose by rasterizing the 2.5D representation. Using a forward reprojection is especially efficient to compute using hardware that is suited for rasterization such as a graphics processing unit.

In another example the reprojection is backward reprojection. Backward reprojection determines, for each pixel, where a reprojected ray cast from a rendering camera extending to a reprojected pixel intercepts the depth channel.

The RGBD frame is the encoded 408 using the reprojected reference frame. The reprojected reference frame is divided into blocks and for each block a motion vector is computed which is a translation describing how to translate the block to best match a region of the RGBD frame to be encoded. Any difference remaining after the translation is recorded as a residual. The resulting motion vectors and residuals are the encoded RGBD frame and are sent to a decoder 104 over any suitable communications network.

The decoder 104 receives 410 the encoded RGBD frame comprising motion vectors and residuals. The decoder accesses 412 the reference frame. The reference frame is a previous RGBD frame of the video. Intra coding is used to send the reference frame to the decoder from the encoder every now and again.

The decoder reprojects the reference frame. The reprojection is done using forward reprojection or backward reprojection as mentioned for the encoder. The reprojection is done using a depth channel of the reference frame and a camera pose. The camera pose is a camera pose of the encoded frame shared between the encoder 100 and decoder 104. In an example the video depicts a 3D scene from a moving camera pose and the motion of the camera pose is used to predict the camera pose used by the decoder 104.

Using the reprojected reference frame, the decoder decodes 418 the motion vectors and residuals. The decoder divides the reprojected reference frame into blocks and translates the blocks according to the motion vectors. Each residual is then added to the respective block. The result is a decoded RGBD frame which is suitable for output 420 to a display.

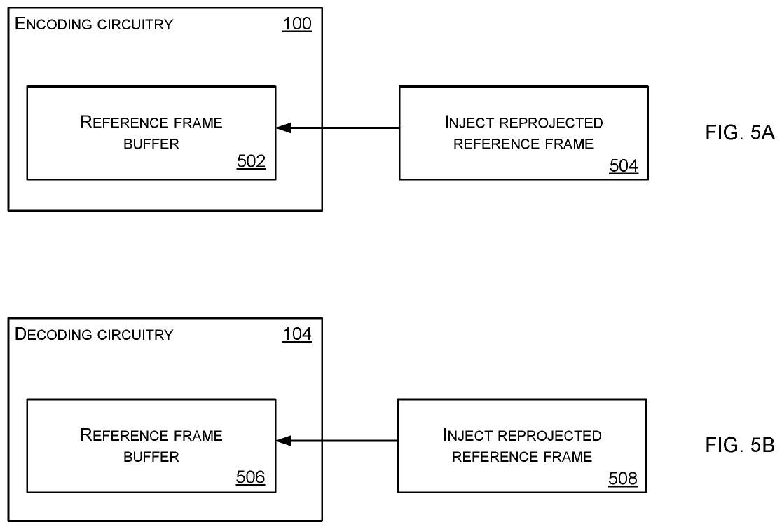

FIG. 5A is a schematic diagram of encoding circuitry 100 which is hardware encoding circuitry for encoding an RGBD frame. The encoding circuitry comprises a reference frame buffer 502 which stores a reference frame. The reference frame buffer is configured to receive an injected reprojected reference frame 504 from a software component of an encoder. In this way an existing hardware encoding circuitry is upgradable to operate with the encoding process described herein.

FIG. 5B is a schematic diagram of decoding circuitry. The encoding circuitry comprises a reference frame buffer 506 which stores a reference frame. The reference frame buffer is configured to receive an injected reprojected reference frame 508 from a software component of a decoder. In this way an existing hardware decoding circuitry is upgradable to operate with the decoding process described herein.

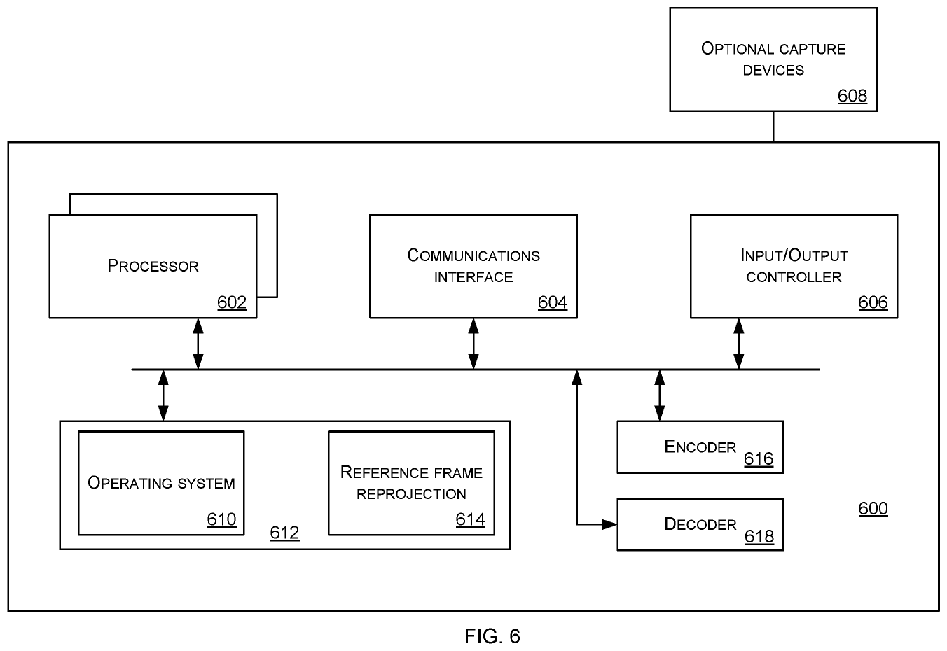

FIG. 6 illustrates an exemplary computing-based device in which embodiments of an encoder and/or decoder are implemented

FIG. 6 illustrates various components of an exemplary computing-based device 600 which are implemented as any form of a computing and/or electronic device, and in which embodiments of an encoder or decoder are implemented in some examples.

Computing-based device 600 comprises one or more processors 602 which are microprocessors, controllers or any other suitable type of processors for processing computer executable instructions to control the operation of the device in order to encode RGBD frames and/or decode RGBD frames. In some examples, for example where a system on a chip architecture is used, the processors 602 include one or more fixed function blocks (also referred to as accelerators) which implement a part of the method of encoding and/or decoding RGBD frames in hardware (rather than software or firmware). Encoder 616 and decoder 618 are implemented using hardware in some examples. Platform software comprising an operating system 610 or any other suitable platform software is provided at the computing-based device to enable application software to be executed on the device. Reference frame reprojection component 614 has functionality to reproject a reference frame as described herein.

The computer executable instructions are provided using any computer-readable media that is accessible by computing based device 600. Computer-readable media includes, for example, computer storage media such as memory 612 and communications media. Computer storage media, such as memory 612, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 612) is shown within the computing-based device 600 it will be appreciated that the storage is, in some examples, distributed or located remotely and accessed via a network or other communication link (e.g. using communication interface 604).

The computing-based device 600 also comprises an input/output controller 606 arranged to output display information to a display device which may be separate from or integral to the computing-based device 600. The input/output controller 606 is also arranged to receive and process input from one or more devices, such as optional capture devices 608.

Alternatively or in addition to the other examples described herein, examples include any combination of the following clauses:

Clause A. A method performed by a decoder, the method comprising:
receiving a compressed red green blue depth, RGBD, frame of a video;
accessing a reference RGBD frame;
reprojecting the reference RGBD frame using a depth channel of the reference RGBD frame and a camera pose, to compute a reprojected version of the reference frame;
using the reprojected version of the reference frame to decode the compressed RGBD frame.

Clause B. The method of clause A wherein the compressed RGBD frame has been obtained by rendering from a 3D model to compute an RGBD frame and then compressing the RGBD frame.

Clause C. The method of clause A or B wherein the compressed RGBD frame depth has been obtained by capturing an RGBD frame of a 3D scene and then compressing the RGBD frame.

Clause D. The method of any preceding clause wherein reprojecting the reference RGBD frame comprises computing a forward reprojection by computing a rendering from a depth channel of the RGBD frame according to the camera pose.

Clause E. The method of any preceding clause wherein reprojecting the reference RGBD frame comprises computing a backward projection by searching a depth buffer.

Clause F. The method of any preceding clause wherein the camera pose is computed from camera pose data shared between the decoder and an encoder which encoded the compressed RGBD frame.

Clause G. The method of clause F wherein the camera pose data shared between the decoder and encoder is shared by sending data about pose of a virtual camera used to render from a 3D model between the encoder and decoder.

Clause H. The method of Clause F wherein the camera pose data shared between the decoder and encoder is shared by sending data about pose of a capture device between the encoder and decoder.

Clause I. The method of any preceding clause wherein the camera pose is related to a pose of a camera used to render the compressed RGBD frame or a pose of a camera used to capture the compressed RGBD frame.

Clause J. The method of any preceding clause wherein the camera pose is in a trajectory of a camera pose of a camera used to render the compressed RGBD frame or a trajectory of a pose of a camera used to capture the compressed RGBD frame.

Clause K. The method of any preceding clause wherein receiving the compressed RGBD frame comprises receiving a plurality of motion vectors and residuals and wherein decoding the compressed RGBD frame comprises applying the motion vectors and residuals to blocks of the reprojected version of the reference frame.

Clause L. The method of any preceding clause wherein decoding the compressed RGBD frame comprises using circuitry comprising a reference frame buffer and injecting the reprojected version of the reference frame into the reference frame buffer.

Clause M. The method of any preceding clause wherein the reference frame is a frame of the video.

Clause N. A method performed by an encoder, the method comprising:
receiving a red green blue depth, RGBD, frame of a video;
accessing a reference RGBD frame;
reprojecting the reference RGBD frame using a depth channel of the reference RGBD frame and a camera pose, to compute a reprojected version of the reference frame;
using the reprojected version of the reference frame to encode the compressed RGBD frame.

Clause O. The method of clause N wherein reprojecting the reference RGBD frame comprises computing a forward reprojection by computing a rendering from a depth channel of the reference RGBD frame according to the camera pose; or wherein reprojecting the reference RGBD frame comprises computing a backward projection by searching a depth buffer.

Clause P. The method of clause N wherein the camera pose is computed from camera pose motion data shared between the decoder and an encoder which encoded the compressed RGBD frame.

Clause Q. The method of clause P wherein the camera pose data shared between the decoder and encoder is shared by sending data about pose of a virtual camera used to render from a 3D model between the encoder and decoder.

Clause R. The method of any preceding clause wherein the camera pose is a camera pose of the compressed RGBD frame.

Clause S. The method of any of clauses N to R wherein encoding the compressed RGBD frame comprises using circuitry comprising a reference frame buffer and injecting the reprojected version of the reference frame into the reference frame buffer.

Clause T. A decoder comprising a processor configured to:
receive a compressed red green blue depth, RGBD, frame of a video;
access a reference RGBD frame;
reproject the reference RGBD frame using a depth channel of the reference RGBD frame and a camera pose, to compute a reprojected version of the reference frame;
use the reprojected version of the reference frame to decode the compressed RGBD frame.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A method performed by a decoder, the method comprising:
receiving a compressed red green blue depth, RGBD, frame of a video;
accessing a reference RGBD frame;
reprojecting the reference RGBD frame using a depth channel of the reference RGBD frame and a camera pose, to compute a reprojected version of the reference frame;
using the reprojected version of the reference frame to decode the compressed RGBD frame.

2. The method of claim 1 wherein the compressed RGBD frame has been obtained by rendering from a 3D model to compute an RGBD frame and then compressing the RGBD frame.

3. The method of claim 1 wherein the compressed RGBD frame depth has been obtained by capturing an RGBD frame of a 3D scene and then compressing the RGBD frame.

4. The method of claim 1 wherein reprojecting the reference RGBD frame comprises computing a forward reprojection by computing a rendering from a depth channel of the RGBD frame according to the camera pose.

5. The method of claim 1 wherein reprojecting the reference RGBD frame comprises computing a backward projection by searching a depth buffer.

6. The method of claim 1 wherein the camera pose is computed from camera pose data shared between the decoder and an encoder which encoded the compressed RGBD frame.

7. The method of claim 6 wherein the camera pose data shared between the decoder and encoder is shared by sending data about pose of a virtual camera used to render from a 3D model between the encoder and decoder.

8. The method of claim 6 wherein the camera pose data shared between the decoder and encoder is shared by sending data about pose of a capture device between the encoder and decoder.

9. The method of claim 1 wherein the camera pose is related to a pose of a camera used to render the compressed RGBD frame or a pose of a camera used to capture the compressed RGBD frame.

10. The method of claim 1 wherein the camera pose is in a trajectory of a camera pose of a camera used to render the compressed RGBD frame or a trajectory of a pose of a camera used to capture the compressed RGBD frame.

11. The method of claim 1 wherein receiving the compressed RGBD frame comprises receiving a plurality of motion vectors and residuals and wherein decoding the compressed RGBD frame comprises applying the motion vectors and residuals to blocks of the reprojected version of the reference frame.

12. The method of claim 1 wherein decoding the compressed RGBD frame comprises using circuitry comprising a reference frame buffer and injecting the reprojected version of the reference frame into the reference frame buffer.

13. The method of claim 1 wherein the reference frame is a frame of the video.

14. A method performed by an encoder, the method comprising:
receiving a red green blue depth, RGBD, frame of a video;
accessing a reference RGBD frame;
reprojecting the reference RGBD frame using a depth channel of the reference RGBD frame and a camera pose, to compute a reprojected version of the reference frame;
using the reprojected version of the reference frame to encode the compressed RGBD frame.

15. The method of claim 14 wherein reprojecting the reference RGBD frame comprises computing a forward reprojection by computing a rendering from a depth channel of the reference RGBD frame according to the camera pose; or wherein reprojecting the reference RGBD frame comprises computing a backward projection by searching a depth buffer.

16. The method of claim 14 wherein the camera pose is computed from camera pose motion data shared between a decoder and an encoder which encoded the compressed RGBD frame.

17. The method of claim 16 wherein the camera pose data shared between the decoder and encoder is shared by sending data about pose of a virtual camera used to render from a 3D model between the encoder and decoder.

18. The method of claim 14 wherein the camera pose is a camera pose of the compressed RGBD frame.

19. The method of claim 14 wherein encoding the compressed RGBD frame comprises using circuitry comprising a reference frame buffer and injecting the reprojected version of the reference frame into the reference frame buffer.

20. A decoder comprising a processor configured to:
receive a compressed red green blue depth, RGBD, frame of a video;
access a reference RGBD frame;
reproject the reference RGBD frame using a depth channel of the reference RGBD frame and a camera pose, to compute a reprojected version of the reference frame;
use the reprojected version of the reference frame to decode the compressed RGBD frame.
